(19) United States
(12) Patent Application Publication
(10) Pub. No.: US 2025/0252328 A1
(43) Pub. Date: Aug. 7, 2025

(54) SYSTEMS AND METHODS FOR OPEN WORLD TEMPORAL LOGIC

(71) Applicants: Paulo Shakarian, Chandler, AZ (US); Dyuman Aditya, Pondicherry (IN); Kaustuv Mukherji, Kolkata (IN)

(72) Inventors: Paulo Shakarian, Chandler, AZ (US); Dyuman Aditya, Pondicherry (IN); Kaustuv Mukherji, Kolkata (IN)

(73) Assignee: Arizona Board of Regents on Behalf of Arizona State University, Tempe, AZ (US)

(21) Appl. No.: 19/044,380

(22) Filed: Feb. 3, 2025

Related U.S. Application Data
(60) Provisional application No. 63/549,314, filed on Feb. 2, 2024.

(51) Int. Cl. G06N 5/048; G06N 5/022; G06N 5/045

(52) U.S. Cl. CPC G06N 5/048; G06N 5/022; G06N 5/045

(57) ABSTRACT

A computer-implemented system/framework is described for performing deduction using generalized annotated logic that captures many of the desired capabilities seen in various neuro symbolic frameworks including fuzzy, open world, temporal, and graph-based reasoning. Specifically, the system includes a core capability to reason about first order (FOL) and propositional logic statements that can be annotated with either elements of a lattice structure or functions over that lattice. The system incorporates a multiple logic method that eliminates the weaknesses associated with using a single logic system and enhances the unique strengths of all the logic systems by using them in concert with each other.

### CROSS REFERENCE TO RELATED APPLICATIONS

This is a non-provisional application that claims benefit to U.S. Provisional Application Ser. No. 63/549,314, filed on Feb. 2, 2024, which is herein incorporated by reference in its entirety.

### FIELD

The present disclosure generally relates to computing and software technologies; and in particular to systems and methods for performing deductions using annotated logic that incorporates neuro symbolic frameworks including the logical systems of fuzzy, open world, and temporal logic, and graph-based reasoning, among other aspects.

### BACKGROUND

The growing popularity of neuro symbolic reasoning has led to the adoption of various forms of differentiable (i.e., fuzzy) first order logic. Various neuro symbolic frameworks utilize an underlying logic to support capabilities such as fuzzy logic, parameterization, and differentiable structures. Typically, implementations of such frameworks create custom software for deduction for the particular logic used, which limits modularity and extensibility.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is an example of a knowledge graph.

FIG. 2 is an example of a lower semilattice structure where the elements are intervals in [0, 1].

FIG. 3 is a snapshot of the described network showing link connections with attribute labels.

FIG. 4 is a Honda® supply chain network; where each node and edge is differently colored as based on the type.

FIG. 5 is a report of the distribution of the nodes in the network based on its GICS type.

FIG. 6 is a report of the edge relationships in the dataset.

FIG. 7 is a schema of a Pokec network.

FIG. 8 is an example method or process including functionality associated with inventive concepts described herein.

FIG. 9 is an example of a computing device which may be implemented as part of aspects of the inventive concept.

Corresponding reference characters indicate corresponding elements among the view of the drawings. The headings used in the figures do not limit the scope of the claims.

### DETAILED DESCRIPTION

The present disclosure relates to systems and methods for implementing a framework based on generalized annotated logic that both captures the current cohort of differentiable logics and temporal extensions to support inference over finite periods of time with capabilities for open world reasoning, dubbed “PyReason.” PyReason can be implemented to directly support reasoning over graphical structures (e.g., knowledge graphs, social networks, biological networks, etc.), produces fully explainable traces of inference, and includes various practical features such as type checking and a memory-efficient implementation. The present disclosure describes various extensions of generalized annotated logic integrated into the modern, efficient Python-based implementation of PyReason that conducts exact yet scalable deductive inference.

### 1. Introduction

Various neuro symbolic frameworks utilize an underlying logic to support capabilities such as fuzzy logic, parameterization, and differentiable structures. Typically, implementations of such frameworks create custom software for deduction for the particular logic used, which limits modularity and extensibility. Further, emerging neuro symbolic use cases including temporal logic over finite time periods and knowledge graph reasoning necessitate the need for a logical framework that encompasses a broad set of capabilities. Fortunately, generalized annotated logic with various extensions capture many of these capabilities.

The inventive concept described herein includes a software package called PyReason for performing deduction using generalized annotated logic that captures many of the desired capabilities seen in various neuro symbolic frameworks including fuzzy, open world, temporal, and graph-based reasoning. Specifically, PyReason includes a core capability to reason about first order (FOL) and propositional logic statements that can be annotated with either elements of a lattice structure or functions over that lattice. Further, PyReason can be implemented to provide for additional practical syntactic and semantic extensions that allow for reasoning over knowledge graphs, temporal logic, reasoning about various network diffusion models, and predicate-constant type checking constraints. This implementation provides for a fast, memory optimized, implementation of the fixpoint operator used in the deductive process. By implementing the fixpoint operator directly (as opposed to a black box heuristic) the underlying software enables full explainability of the result. As such is the case, this framework can capture not only classical logic, but a wide variety of other logic frameworks including fuzzy logic, weighted real valued logic used in logical neural networks, van Emden's logic, Fitting's bilattice logic, various logic frameworks for reasoning over graphs or social networks (as well as the various network diffusion models captured by those frameworks), and perhaps most importantly, logic frameworks where syntactic structure can be learned using differentiable inductive logic programming as well as other neuro symbolic frameworks. Some key advantages of the approach described herein include the following:
1. Direct support for reasoning over knowledge graphs. Knowledge graph structures are one of the most commonly used representations of symbolic data. While black box frameworks also permit for reasoning over graphical structures, they do not afford the explainability of the subject approach.
2. Support for annotations. Classical logic implementations such as Prolog and Epilog inherently do not support annotations or annotation functions, hence lack direct support for capabilities such as fuzzy operators. Further, the inventive framework described herein goes beyond support for fuzzy operators by enabling arbitrary functions that can be used over real values or intervals of reals. This is a key advantage to reasoning about constructs learned with neuro symbolic approaches.
3. Temporal Extensions. A semantic structure can be used that represents multiple time points, and this can further be implemented in a compact manner to preserve memory. The described solution allows for fuzzy versions of rules such as “if q(A) then r(A) in t time steps.” Note that these capabilities are not present in nearly every current implementation of fuzzy logic.
4. Use of interpretations. Interpretations can be defined as annotated function over predicates and time together. This accommodates for the capture of facts which are true before t=0. While annotated logic can subsume various temporal logics without additional constructs, temporal reasoning can be enabled through incorporating a temporal component in interpretations. By combining annotated predicates and the time variable, its is believed that the present framework is more flexible and suitable for emerging neuro symbolic applications involving time—as such applications will inherently require both time and real-valued annotations. Additionally, it is to be noted a closed world assumption is not made; i.e., anything that is not mentioned in the initial set of interpretations is false. Instead, all other interpretations are considered to be unknown at the beginning of time.
5. Graphical Knowledge Structures. A logic programming approach (e.g., P. Shakarian, G. I. Simari, D. Callahan, Reasoning about complex networks: A logic programming approach, Theory Pract. Log. Program. 13 (2013)) can be implemented which provides graphical syntactic extensions to annotated logic programming as described in “Theory of generalized annotated logic programming and its applications.” (M. Kifer, V. Subrahmanian, Theory of generalized annotated logic programming and its applications, J. Log. Program. 12 (1992) 335-367.) This can be included in various implementations of the inventive concept herein, notably adding extended syntactic operators for reasoning in such structures (e.g., an existential operator requiring the existence of k items). An example of such a rule would be a fuzzy version of “if q(A) and there exist k number of B's such that b(A,B) then r(A)”. Note that while this example is classical, PyReason supports fully annotated logic, allowing for arbitrarily defined fuzzy operators (e.g., t-norms) as described in section 2 and other portions herein.
6. Reduction to computational complexity due to grounding. Our software leverages both the inherent sparsity of the graphical structure along with a novel implementation of predicate-constant type checking constraints that significantly improves utility in a variety of application domains but also provide drastic reduction to complexity induced by the grounding problem. We are not aware of any other framework for first-order logic that provides both such capabilities.
7. Ability to detect and resolve inconsistencies in reasoning. As logical inferences are deduced through applications of the fixpoint operator over predefined logical rules, logical inconsistencies can not only be detected but also located exactly where in the inference process the inconsistency occurred. Any such inconsistencies can be resolved by leveraging uncertainty. In a software implementation, as soon as an inconsistency is detected, the bounds can be relaxed and fixed to complete uncertainty. The ability to check and locate inconsistencies enhance the explainability feature. Neuro symbolic approaches may also look to leverage inconsistency as part of loss during the training phase.

### 2. Logical Framework

In this section, an overview of the annotated logic framework with a high-level description of the logical constructs, knowledge graph structure, key optimizations, and operation of the fixpoint algorithm is provided.

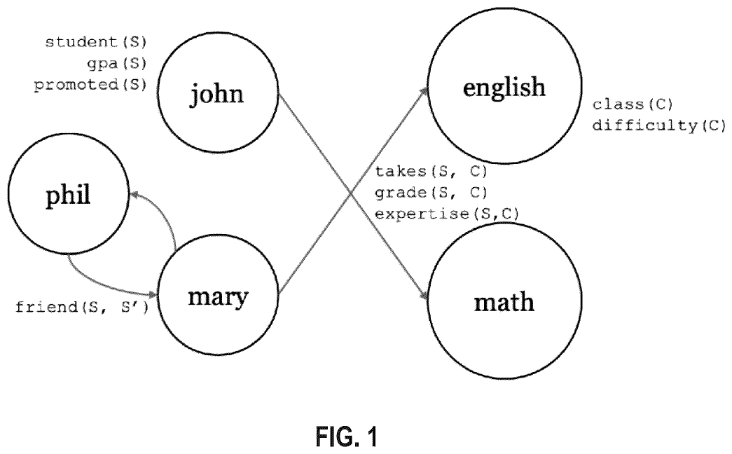

Knowledge graph. We assume the existence of a graphical structure G=( [symbol] , E) where the nodes are also constants (denoted set [symbol] ) in a first-order logic framework. The edges, denoted E⊆ [symbol] × [symbol] , specify whether any type of relationship can exist between two constants. Similar to recent frameworks combining knowledge graphs and logic, we shall assume that all predicates in the language are either unary (which can be thought of as labeling nodes) or binary (which can be thought of as labeling edges). We note that we assume the existence of a special binary predicate rel, which we shall treat as a reserved word. For (a, b)∈E we shall treat rel(a, b) as a tautology and for (a, b)∉E we shall treat rel(a, b) as uncertain. Note that we can support no restrictions among the pairing of constants by creating G as a fully connected graph. Likewise, we easily support the propositional case by using a graph of a single node (essentially treating unary predicates as ground atoms). We provide a running example in this section. In FIG. 1, we illustrate how a knowledge graph is specified in our framework.

### Example 2.1 (Knowledge Graph)

Consider the following nodes: three students—Phil, John, Mary and two classes—English and Math. Nodes and edges have unary and binary predicates as shown in FIG. 1. Hence we get the following non-ground atoms:
student(S), gpa(S), promoted(S)
class(C), difficulty(C)
friend(S, S′)
takes(S, C), grade(S, C), expertise(S, C)
Here, S, S′, and C are variables which when grounded with constants from the graph, produce ground atoms such as:
student(john), student(phil), student(mary)
class(math), class(english)
takes(john, math), takes(mary, english)

In the propositional case, a non-ground atom reduces to a propositional statement. For, e.g., The predicate “takes(john,math)” can be represented as a propositional statement: “John takes Math class” and can be either True or False. It is true in this example, as shown in FIG. 1.

Real-valued Interval Annotations. A key advantage of annotated logic is the ability to annotate the atoms in the framework with elements of a lattice structure as well as functions over that lattice. In software implementations of the subject inventive concept, we use a lower lattice structure consisting of intervals that are a subset of [0, 1]. This directly aligns with the truth interval for fuzzy operators, as well as paradigms in neuro symbolic reasoning, and social network analysis. We can fully support scalar-valued annotations by simply limiting manipulations to the lower bound of the interval and keeping the upper bound set at 1. These annotations can support classical logic by limiting annotations to be [0, 0](false) and [1, 1](true). It can also support tri-valued logic by permitting [0, 1], which represents no knowledge. Of course, there is no need to conduct restrictions, especially if it is desirable to support logics that make full use of the interval. Additionally, we support literals as detailed in Kifer et al. (M. Kifer, V. Subrahmanian, Theory of generalized annotated logic programming and its applications, J. Log. Program. 12 (1992) 335-367). We treat negations the same way as in Badreddine et al. (S. Badreddine, A. d'Avila Garcez, L. Serafini, M. Spranger, Logic tensor networks, Artificial Intelligence 303 (2022) 103649)—for an atom annotated with [ [symbol] , u], we annotate its strong negation(¬) with [1−u, 1− [symbol] ].

### Example 2.2 (Real-valued Interval Annotations)

Continuing with the previous example, we can support a variety of annotations as described above.

### Propositional Logic:

student(john): [1, 1](example of a True statement)
takes(mary, math): [0, 0](example of a False statement)

### Fuzzy Logic (Using Scalar Values):

gpa(john): [X, 1], X∈[0, 1]

### Full Interval Usage:

difficulty(english): [0.3,0.7](both bounds are used here to capture the variation among students regarding the perceived difficulty of the subject “english”).
   Modeling Uncertainty and/or Tri-Valued Logic:
Let's assume that we do not have complete knowledge of this network—specifically, we do not have any information about the friendship between John and Phil. So, they might befriends (annotated [1,1]) or not friends (annotated [0,0]). Our framework can model such a case as:
friend(john, phil): [0,1]

Interpretations. Commonly in logic frameworks, an initial set of facts is used. We use the term “initial interpretations” to capture annotations correct at the beginning of a program. In the envisioned domains—to include the ones in which we perform experiments—these initial interpretations shall be represented as a knowledge graph that not only includes graph G but also attributes on the nodes and edges (resembling predicates) and real-valued interval annotations (specifying the initial annotations for each element). Additionally, following intuitions from various temporal logic frameworks that incorporate both temporal and other real-valued annotations, we extend our syntax to provide for temporal annotations as part of the interpretations. Following the related work, time is represented as finite discrete time-points. The initial interpretations comprises what is to be treated as true before time 0. Further, with the initial interpretations we can specify predicates as being either static (in other words, ground atoms formed with those predicates retain the same annotation across all time periods) or non-static (which are permitted to change). The ability to add this restriction has clear benefit in certain domains, and also allows for key implementation efficiencies for reasoning across time periods. Further, it is noted various inductive logic programming paradigms utilize “extensional” predicates that are also unchanging—which could be treated as “static” in PyReason.

### Syntax:

I(A, \hat{t}):[L, U]
where, A can be an atom (propositional case) or predicate (first order logic), \hat{t} is either the time point T=t for which the interpretation I is valid, or if the interpretation is static, i.e. remains unchanged for all time-points then \hat{t}=s. So,

$$\hat{t} = \{ \begin{matrix}s , & if I ( A , \hat{t} ) is static \\ t , & t ∈ T if I ( A , \hat{t} ) is time - variant\end{matrix} \qquad ( 1 )$$

Annotation [L, U]→[0, 1](or, in propositional case [L, U]∈[0, 0], [1, 1]). We incorporate literals in our system by having separate interpretations for an atom and its negation. We note that, excepting the case of static atoms, ground atoms at different time points need not be dependent upon each other. For example, atom “a” at time 1 can be annotated with [0.5, 0.7] and annotated with [0.1, 0.2] at time 2. There is no monotonicity requirement between time points.

### Example 2.3 (Interpretations)

Continuing the previous example,
Initial set of facts regarding student enrollment:
   I(student(john),0)=[1,1](John is enrolled as a student)
   I(student(mary),0)=[1,1](Mary is enrolled as a student)
   I(student(phil),0)=[0,0](Phil is not enrolled as a student)
Static interpretations can be used for always true facts like:
   I(class(english), s)=[1,1](English is a class offered at all time-points)
Using temporal annotation to capture variation over time:
   I(takes(john, math),1)=[1,1](John takes Math class at time t=1)
   I(takes(john, math),5)=[0,0](But is no longer taking Math at t=5)
All other interpretations, if unspecified at t=0, are initialized with [0, 1].

Logical Rules. Rules are the key syntactic construct that enables changes to atoms formed with non-static predicates. Historically logical rules had mostly been written by domain experts, until early work like Apriori and FOIL to learn association rules from data followed by the emergence of rule mining techniques like causal rule mining and annotated probabilistic temporal logic. More recently, there has been research on Differentiable Inductive Logic Programming (∂ILP)—an inductive rule learning method to learn logical rules from examples. In the below list UnaSet and BinSet are arbitrarily sets of unary and binary predicates relevant to the rules while pred is always a non-static predicate. Note that the total number of atoms in the body is assumed to be n (across all different conjunctions). The symbol ∃ₖ means there exists at least k number of constants such that the ensuing logical sentence is satisfied.
1. Ground rule for reasoning within a single constant or edge:

$$pred ( c ) : f ( {x}_{1} , … , {x}_{n} ) {←}_{Δ t} {⋀}_{{pred}_{i} ∈ UnaSet} {pred}_{i} ( c ) : {x}_{i}$$

$$pred ( c , {c}^{′} ) : f ( {x}_{1} , … , {x}_{n} ) {←}_{Δ t} {⋀}_{{pred}_{i} ∈ BinSet} {pred}_{i} ( c , {c}^{′} ) : {x}_{i}$$

2. Universally quantified non-ground rule for reasoning within a single constant or edge:

$$∀ X : pred ( X ) f ( {x}_{1} , … , {x}_{n} ) {←}_{Δ t} {⋀}_{{pred}_{i} ∈ UnaSet} {pred}_{i} ( c ) : {x}_{i}$$

$$∀ X , {X}^{′} s . t . ( X , {X}^{′} ) ∈ E : pred ( X , {X}^{′} ) : f ( {x}_{1} , … , {x}_{n} ) {←}_{Δ t} {⋀}_{{pred}_{q} ∈ BinSet} {pred}_{q} ( X , {X}^{′} ) : {x}_{q} ⋀ {⋀}_{{pred}_{r} ∈ UnaSet} {pred}_{r} ( X ) : {x}_{r} ⋀ {⋀}_{{pred}_{s} ∈ {UnaSet}^{′}} {pred}_{s} ( {X}^{′} ) : {x}_{s}$$

3. Universally quantified non-ground rule for reasoning across an edge:

$$∀ X : pred ( X ) : f ( {x}_{1} , … , {x}_{n} ) {←}_{Δ t} {∃}_{k} {X}^{′} : rel ( X , {X}^{′} ) : [ 1 , 1 ] ⋀ {⋀}_{{pred}_{q} ∈ BinSet} {pred}_{q} ( X , {X}^{′} ) : ⋀ {⋀}_{{pred}_{r} ∈ UnaSet} {pred}_{r} ( X ) : {x}_{r} ⋀ {⋀}_{{pred}_{s} ∈ {UnaSet}^{′}} {pred}_{s} ( {X}^{′} ) : {x}_{s}$$

4. Non-ground rule with rule based quantifier in the head:

$$pred ( X ) : [ {A}_{s} ( {l}_{1} , {l}_{2} , … , {l}_{n} ) , {A}_{s} ( {u}_{1} , {u}_{2} , … , {u}_{n} ) ] ← ⋀ {x}_{{i}^{s . t . ( X , {X}_{i} ) ∈ E}} {pred}^{′} ( X , {X}_{i} ) : [ {l}_{i} , {u}_{i} ]$$

Here, A_{s,m}^{k} could be the m^{th} rule based quantifier defined over set S such that, A_{s,m}^{k}(s)=k^{th} highest value in set S.

### Example 2.4 (Logical Rules)

For the continuing example we can formulate some interesting rules based on the formats given above as:
1.

$$promoted ( X ) : [ T ( {l}_{1} , {l}_{2} ) , U ( {u}_{1} , {u}_{2} ) ] {←}_{Δ t = 1} student ( X ) : [ {l}_{1} , {u}_{1} ] ⋀ gpa ( X ) : [ {l}_{2} , {u}_{2} ]$$

which says, “If X is a student with bounds [l₁, u₁] and has a gpa with bounds [l₂, u₂], then X is likely to be promoted, at the next timestep, with bounds given by a function of [l₁, u₁] and [l₂, u₂].”

Here, T could be a T-norm. Some well known examples of T-norms are:

(a) Minimum: T(a,b)=Tₘᵢₙ(a,b)=min(a,b)

(b) Product: T(a,b)=T_{prod}(a,b)=a·b

(c) Łukasiewicz: T(a,b)=Tₗᵤₖ(a,b)=max(O,a+b−1)
PyReason also supports other well-known logical functions like T−conorm, algebraic functions like max, min, average, among others.
2.

$$∀ X , Y expertise ( X , Y ) : [ 0.6 * L , 1 ] {←}_{Δ t = 0} grade [ X , Y ] : [ L , 1 ] ⋀ student ( X ) : [ 1 , 1 ] ⋀ class ( Y ) : [ 1 , 1 ]$$

which says, “If X is a student who obtains a grade [L, 1] in class Y, then we can estimate X's expertise of subject Y by defining an annotation function [0.6*L, 1] over a single annotation [L, 1].”
3.

$$gpa ( john ) [ \frac{{x}_{1} + {x}_{2}}{2} , 1 ] {←}_{Δ t = 0} {∃}_{i = 2} {C}_{i} ∈ 𝒞 ; class ( {C}_{i} ) : [ 1 , 1 ] ⋀ takes ( john , {C}_{i} ) : [ 1 , 1 ] ⋀ grade ( john , {C}_{i} ) : [ {x}_{i} , 1 ]$$

which says, “If john takes and earns grades for two classes, then his gpa can be calculated using the algebraic function avg in the head of the given existentially quantified ground rule.”
4.

$$friend ( S , {S}^{′} ) : [ 1 , 1 ] {←}_{Δ t = 2} takes ( S , C ) : [ 1 , 1 ] ⋀ takes ( {S}^{′} , C ) : [ 1 , 1 ] ⋀ class ( C ) : [ 1 , 1 ]$$

a propositional rule with temporal extension which states, “If two students S and S′ take the same class C, they develop a friendship after two timesteps.”
5.

$$∀ S , {S}^{′} , {S}^{″} friend ( S , {S}^{′} ) : [ 1 , 1 ] {←}_{Δ t = 1} friend ( S , {S}^{′} ) : [ 1 , 1 ] ⋀ friend ( {S}^{′} , {S}^{″} ) : [ 1 , 1 ]$$

an universally quantified non-ground rule analogous to the associative rule in mathematics which encapsulates, “Having a common friend S′ leads to friendship between two people S and S″.”

Fixpoint Operator for Deduction. Central to the deductive process is a fixpoint operator (denoted by F) which has previously been proven to produce all atoms entailed by a logic program. It is noteworthy that this is an exact computation of the fixpoint, and hence providing the minimal model associated with the logic program allowing one to easily check for entailment of arbitrary formulae. Further, the result is fully explainable as well: for any entailment query we would have the series of inference steps that lead to the result. This differs significantly from other frameworks that do not provide an explanation for deductive results though a key difference is that the reasoning framework implemented in PyReason allows for exact and efficient polynomial time inference, while others have an intractable inference process.

### Example 2.5 (Fixpoint Operator(Γ))

Consider we have the following set of initial interpretations in addition to the ones specified before:
I(takes(john, english),1)=I(takes(john, english),2)=[1,1]
I(takes(mary, english),2)=I(takes(mary, english),3)=[1,1]
(John takes English at t=1,2 and Mary takes English at t=2,3)
I(friend(mary,phil), s)=[1,1]
(Mary and Phil are friends for the entire time considered)
And we consider the rule set R to be made of rule 4 and 5 from above. We initialize:
∀S,S′ I(friend(S,S′),0)=[0,1] (all friend relationships initialized as unknown) and then update:
I(friend(mary, phil), s)=[1, 1] (from initial interpretations)
Application of Γ at T=0 and 1 yields no change in I as none of the rules are fired.
At T=2, rule 4 fires with the following groundings:

$$friend ( john , mary ) : [ 1 , 1 ] {←}_{Δ t = 2} takes ( john , english ) : [ 1 , 1 ] ⋀ takes ( mary , english ) : [ 1 , 1 ] ⋀ class ( english ) : [ 1 , 1 ]$$

$$friend ( mary , john ) : [ 1 , 1 ] {←}_{Δ t = 2} takes ( mary , english ) : [ 1 , 1 ] ⋀ takes ( john , english ) : [ 1 , 1 ] ⋀ class ( english ) : [ 1 , 1 ]$$

This would result in a change in I at T=4, as ΔT=2 for the rule above and it is fired at T=2.
I(friend(john, mary),4)=[1,1]
I(friend(mary,john),4)=[1,1]
At T=3, as I is still unchanged, application of Γ does not lead to any of the rules firing.
At T=4, application of Γ with the updated interpretation leads to firing of grounded rule 5 as:

$$friend ( john , phil ) : [ 1 , 1 ] {←}_{Δ t = 1} friend ( john , mary ) : [ 1 , 1 ] ⋀ friend ( mary , phil ) : [ 1 , 1 ]$$

And results in:
I(friend(John, phil), 5)=[1, 1]

The above illustrates how PyReason makes logical inferences by exact application of the fixpoint operator(Γ). In this example, we are able to trace how the interpretation I(friend(john, phil), t) changed over time, and which rules caused these changes. This shows that this process is completely explainable, and can be leveraged in emerging neuro symbolic applications.

Constant-Predicate Type Checking Constraints. Key to reducing the complexity and speeding up of the inference process is type-checking. We leverage the sparsity commonly prevalent in knowledge graphs to significantly cut down on the search space during the grounding process. We noticed that typically a graph will have nodes of different types, and predicates typically were defined only over constants of a specific type. While initializing the interpretations, type checking takes this into account and only creates ground atoms for the subset of predicate-constant pairs which are compatible with each other. However, we note that this is an option, as in some applications such information may not be available.

### Example 2.6 (Constant-Predicate Type Checking)

In the continuing example we see that the predicates student, gpa, promoted are only limited to constants of type student. Similarly, predicates class, difficulty are exclusive to the constants english and math. Type checking ensures that we do not consider ground atoms like student(english) or class(phil).

Likewise for binary predicate takes(S, C), the first variable is always grounded with a student type constant, and the second with a class type constant. Even in this miniature example, type checking reduces the number of ground atoms under consideration from 25 to only 6—a 76% reduction. Such gains significantly reduce complexity as size and sparsity of the graph increases.

Detecting and Resolving Inconsistencies. Inconsistency can occur in the following cases:
1. For some ground atom, a new interpretation is assigned an annotation [L′, U′] that is not a subset of the current interpretation [L, U] (we assume L≤U). i.e. if either U<L′ or U′<L.
2. When an inconsistency occurs between an atom and its negation like “a” and “not a”. Or between complementary predicates like “bachelor(X)” and “married(X)” which cannot hold simultaneously.
   e.g. Literal A has annotation [L₁, U₁] and Literal B is the negation of literal A with annotation [L₂, U₂]. The fixpoint operator attempts to assign [L′₁, U′₁] to Literal A, and [L′₂, U′₂] to Literal B. But new bounds are inconsistent, i.e. either L′₁>1−L′₂ or U′₁<1−U′₂.

PyReason flags all such inconsistencies arising during the execution of the fixpoint operator and reports them. Further, as the fixpoint operator provides an explainable trace, the user can see the precise cause of the inconsistency. As an additional, practical feature, PyReason includes an option to reset the annotation to [0, 1] for any identified inconsistency and set the atom to static for the remainder of the inference process. In this way, such inconsistencies cannot propagate further. These initial capabilities provide a solid foundation for more sophisticated consistency management techniques such as providing for local consistency or iterative relaxation of the initial logic program.

### Example 2.7 (Detecting and Resolving Inconsistencies.)

Consider we have the following prior knowledge:
I(takes(phil, math), 4)=[1, 1]
I(takes(mary, math), 4)=[1, 1]
I(friend(phil, mary), 5)=[0, 0]
   However, the following logical rule with grounding S←phil, S′←mary, C←math:

$$friend ( S , {S}^{′} ) : [ 1 , 1 ] {←}_{1} takes ( S , C ) : [ 1 , 1 ] ⋀ takes ( {S}^{′} , C ) : gets fired at t = 4.$$

resulting in:
I(friend(phil, mary), 5)=[1, 1]
   But clearly this is an inconsistency as I(friend(phil, mary), 5) cannot be both [0, 0] and [1, 1] simultaneously. So, we conclude that at least one of those two interpretations must be incorrect. If there is no way to ascertain which is correct, we may resolve this logical inconsistency by setting:
I(friend(phil, mary), s)=[0, 1] at t=5.

### 3. Implementation Example

The present disclosure illustrates an inventive modern Python-based framework to support scalable yet correct reasoning. Graphical input can be allowed via convenient Graphml format, which is commonly used in knowledge graph architectures. The python library Networkx can be used to load and interact with the graph data. Some implementations can directly support Neo4j. The initial conditions and rules can be entered in YAML format and memory-efficient implementation techniques can be used to correctly capture semantic structures. The Numba open-source JIT compiler can be used to translate many key operations into fast, optimized machine code while allowing the user to interact with Python and the aforementioned front-ends. Example implementations can support CPU parallelism, as evidenced by experiments of the inventive framework run on multi-CPU machines.

The present software stores interpretations in a nested dictionary. For computational efficiency and ease of use, the software allows specification of a range of time-points T=t₁, t₂ . . . instead of a single time-point t, for which an interpretation I remains valid. To reduce memory requirements, only the one set of interpretations (current) are stored at any point in time. However, past interpretations can be obtained using rule traces, which retains the change history for each interpretation and the corresponding grounded logical rules that caused each change. Rule traces make the software completely explainable, as every inference can be traced back to the cascade of rules that led to it.

TABLE 1
Honda network: How disruption on a country’s industry,
caused by a pandemic, may spread worldwide

| | | Companies disrupted across the world at | | | | | | | % of companies | | |
|---|---|---|---|---|---|---|---|---|---|---|---|
| Companies | | time t= | | | | | | | disrupted | | |
| Based | Count | 0 | 1 | 2 | 3 | 4 | | 38 | Initial | Final | Change |
| USA | 1599 | 1599 | 1965 | 2057 | 2203 | 2313 | . . . | 3336 | 14.68 | 30.75 | 16.07 |
| Taiwan | 603 | 603 | 644 | 647 | 647 | 647 | . . . | 647 | 5.54 | 5.94 | 0.40 |
| Australia | 128 | 128 | 131 | 131 | 131 | 131 | . . . | 131 | 1.18 | 1.21 | 0.03 |

MANCaLog showed the use of the fixpoint operator for both canonical and non-canonical models. By recomputing interpretations at every time step, significantly less memory is required and also support is provided to both the canonical and the non-canonical cases. Due to this design, increase in computation time is observed to be minimal.

Furthermore, significant advances are made by supporting static predicates, and having in-built capabilities for non-graph reasoning, and type checking as detailed in section 2. Detailed pseudo-code can be found in the supplemental information below.

### 4. Experiments

### 4.1 Honda Buyer-Supplier Dataset

We conducted our experiment on a Honda Buyer-Supplier network. The dataset (network) contains 10,893 companies (nodes) and 47,247 buyer-supplier relationships between them (edges).

We design a use case, where we assume that operations of all companies from a particular country are disrupted, and observe the effects that this may have on companies across the world. We feel this is akin to supply chain issues faced worldwide during the COVID-19 pandemic. For our tests, we use the following logical rule which in practice would be either learned or come from an expert.

$$disrupted ( Buyer ) : [ 1 , 1 ] {←}_{Δ t = 1} {∀}_{k} supplies ( {Sup}_{k} , Buyer ) : [ 1 , 1 ] , {∃}_{k / 2} disrupted ( {Sup}_{k} ) : [ 1 , 1 ]$$

It states that, a company is disrupted at a particular timestep if at least 50% of its suppliers are totally disrupted in the previous timestep. We conduct this experiment for three different countries (USA, Taiwan, and Australia), having a wide range of proportion of companies in the dataset. We do not fix the number of inference steps, instead we let the diffusion process run until it converges (in bold). The results are shown in Table 1.

To test if our approach could scale, we use two inference rules which jointly state, a company is disrupted at a particular timestep if any of its supplier(s) are completely disrupted in the previous timestep, or if at least 50% of its suppliers are disrupted to at least 50% of their capacity. We conduct this experiment for different graph sizes, and for different number of timesteps to show the scaling capability of our software in Table 2.

TABLE 2
Scalability of our framework

| Nodes | Edges | Total | | | Runtime (in | Memory (in |
|---|---|---|---|---|---|---|
| (N) | (E) | attributes | Density | Timesteps | s) | MB) |
| 1000 | 410 | 5012 | 4.10 × | 2 | 0.35 | 12.2 |
| | | | 10⁻⁴ | 5 | 0.40 | 14.8 |
| | | | | 15 | 0.43 | 26.4 |
| 2000 | 1640 | 13269 | 4.10 × | 2 | 0.40 | 13.6 |
| | | | 10⁻⁴ | 5 | 0.49 | 15.7 |
| | | | | 15 | 0.73 | 30.0 |
| 5000 | 10244 | 57852 | 4.10 × | 2 | 1.35 | 58.6 |
| | | | 10⁻⁴ | 5 | 1.76 | 73.2 |
| | | | | 15 | 3.09 | 157.4 |
| 10000 | 41034 | 197752 | 4.10 × | 2 | 4.25 | 183.3 |
| | | | 10⁻⁴ | 5 | 6.11 | 235.9 |
| | | | | 15 | 11.20 | 549.1 |

The results show that both runtime and memory remain almost constant over large ranges, and then scale sub-linearly with increase in network size.

### 4.2 Pokec Social Media Dataset

Pokec is a popular slovakian social network, and this dataset contains personal information like gender, age, pets (attributes) of 1.6 million people (nodes), and 30.6 million connections between them (edges).

We take inspiration from the advertising community to design our use case. We consider, a small proportion of the population, who has pet(s), to be customers of a pet food company. The company, using Pokec data, must identify relevant advertising targets among the population. A realistic strategy can be captured by two logical rules:

$$1 . ∀ X , Y relevance ( X ) : [ 0.6 , 1 ] {←}_{Δ t = 1} friend ( X , Y ) : [ 1 , 1 ] ⋀ relevance ( Y ) : [ 1 , 1 ]$$

Friend of a relevant target or existing customer (always relevant), is at least 60% relevant.

$$2. ∀ X , Y relevance ( X ) : [ 1 , 1 ] {←}_{Δ t = 1} relevance ( Y ) : [ 1 , 1 ] ⋀ friend ( X , Y ) : [ 1 , 1 ] ⋀ hasPet ( X , P ) : [ 1 , 1 ] ⋀ hasPet ( Y , P ) : [ 1 , 1 ]$$

Friend of a relevant target is totally relevant if they have pet(s) of same kind—dog, cat, . . .

The diffusion process converged after 3 timesteps, took 77 minutes to complete and used 84.42 GB of memory—which further showcases the scalability of our framework. The results are shown in Table 3.

The process of inference is completely explainable, and an user may use rule traces, an optional output of PyReason, to identify the logical rules that led to change in each interpretation. An example of a rule trace from the previous experiment is presented in Table 4.

All experiments were performed on an AWS EC2 container with 96 vCPUs (48 cores) and 384 GB memory.

TABLE 3
Pokec social media: How brands may use consumer
data to identify prospective customers

Advertising targets

| Population | Current | | Fully | Partially |
|---|---|---|---|---|
| size | Customers | Timesteps | relevant | relevant |
| 1,632,803 | 2,308 | 0 | 2,308 | 0 |
| | | 1 | 2,596 | 1,430,292 |
| | | 2 | 4,758 | 1,428,130 |
| | | 3 | 4,758 | 1,428,130 |

TABLE 4
Rule trace for a single node for label relevance. Application of rule 1 above caused the first
change from [0, 1] to [0.6, 1], followed by, an update to [1, 1] due to firing
of rule 2. A list of node and edge IDs which were used to ground the rule clauses are also provided.

| | Old | New | Rule | | | | |
|---|---|---|---|---|---|---|---|
| t | Bound | Bound | fired | Clause-1 | Clause-2 | Clause-3 | Clause-4 |
| 1 | [0.0, 1.0] | [0.6, 1.0] | rule_1 | [(‘1277197’, | | | |
| | | | | ‘359728’), . . . ] | | | |
| 3 | [0.6, 1.0] | [1.0, 1.0] | rule_2 | [‘359728’, . . . ] | [(‘1277197’, | [(‘802185’, | [(‘1277197’, |
| | | | | | 359728’), . . . ] | cat’)] | ‘cat’)] |

### Supplemental Information

### A. Formal Syntax and Semantics.

We now recapitulate the definition of Generalized Annotated Logic programs (from now on referred to as “GAPs”, for short) as well as the extensions that we include in our software.

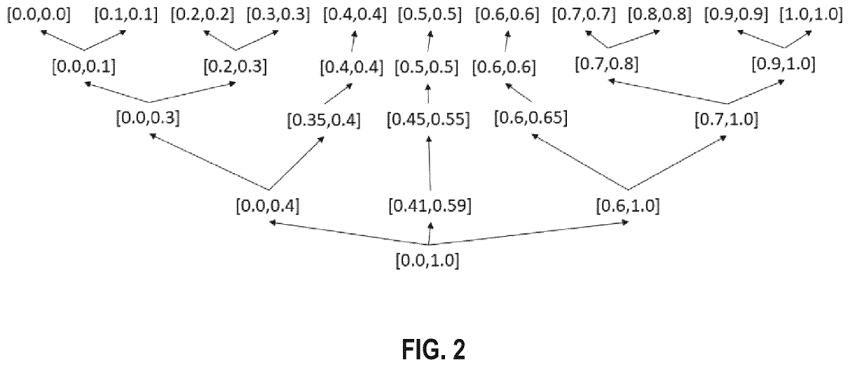

In Kifer et al. (M. Kifer, V. Subrahmanian, Theory of generalized annotated logic programming and its applications, J. Log. Program. 12 (1992) 335-367), the authors assumed the existence of a semilattice. [symbol] (not necessarily complete) with ordering [symbol] . To support contemporary applications in neuro symbolic reasoning as well as social network analysis, we implemented this as a lower semilattice structure. Therefore, we have a single element I and multiple top elements T₀, . . . Tᵢ . . . Tₘₐₓ. The notation height( [symbol] ) is the maximum number of elements in the lattice in a path between ⊥ and a top element (including ⊥ and the top element)¹. The employment of a lower semilattice structure allows enables two desirable characteristics. First, we desire to annotate atoms with intervals of reals in [0, 1]. Second, it allows for reasoning about such intervals whereby the amount of uncertainty (i.e., for interval [l, u] the quantity u− [symbol] decreases monotonically as an operator proceeds up the lattice structure. Therefore, we define bottom element ⊥=[0, 1] and a set of top elements {[x, x]|[x, s]⊆|0, 1|} (see note²). Specifically, we set T₀=[0, 0] and Tₘₐₓ=[1, 1]. An example of such a semilattice structure is shown in FIG. 2. ¹ In general, we shall assume that the lattice consists of finite, discrete elements.²N.B. that when using a semilattice of bounds, the notation “ [symbol] ” loses its “subset intuition”, as [0, 1] [symbol] [1, 1] in this case, for example.

As with Kifer, we assume the existence of a set AVar of variable symbols ranging over [symbol] and a set [symbol] of function symbols, each of which has an associated arity. We start by defining annotations.

Definition A.1 (Annotation). (i) Any member of [symbol] ∪AVar is an annotation. (ii) If ƒ is an n-ary function symbol over [symbol] and t₁, . . . , tₙ are annotations, then ƒ(t₁, . . . , tₙ) is an annotation.

One specific function we define is “¬” which is used in semantics of [6] as well as the more recent interval-based framework used in [2]. For a given [l, u], ¬([l, u])=[1−u, 1−l]. Note that we also use the symbol [symbol] in our first-order language (following the formalism of Kifer). We define a separate logical language whose constants are members of set, [symbol] and whose predicate symbols are specified by set [symbol] . We also assume the existence of a set [symbol] of variable symbols ranging over the constants, that no function symbols are present, and terms and atoms are defined in the usual way (cf. J. W. Lloyd, Foundations of logic programming, Springer-Verlag New York, Inc., 1987.). We shall assume that [symbol] are discrete and finite. In general, we shall use capital letters for variable symbols and lowercase letters for constants. We shall assume that all elements of [symbol] have an arity of either 1 or 2—so we shall denote these [symbol] ᵤₙₐ for unary predicates and [symbol] ᵣₑₗ for binary predicates. We shall also denote a subsets of [symbol] to include “target predicates” written [symbol] _{tgt} that can consist of either binary or unary predicates ( [symbol] _{tgt_rel}, [symbol] _{tgt_una}) provided that they are not reserved words. We shall use the symbol [symbol] to denote the set of all ground literals and [symbol] for the set of all ground atoms. We now define the syntactical structure of GAPs that will be used in this work.

Definition A.2 (Annotated atoms, negations, literals). The core syntactic structures are defined as follows:
Annotated atom. If a is an atom and μ is an annotation, then a:μ is an annotated atom.
Annotated Negation. If + is an atom and μ is an annotation, then ¬a:μ is an annotated negation.
Annotated Literal. Collectively, atoms and negations are referred to as annotated literals.

Definition A.3 (GAP Rule). If [symbol] ₀:μ₀, [symbol] ₁:μ₁, . . . , [symbol] ₘ:μₘ are annotated literals (such that for all i, j∈1, m, [symbol] ᵢ≢ [symbol] ⱼ, then

$$r ≡ {ℓ}_{0} : {μ}_{0} ← {ℓ}_{1} : {μ}_{1} ⋀ … ⋀ {ℓ}_{m} : {μ}_{m}$$

is called a GAP rule. We will use the notation head(r) and body(r) to denote [symbol] ₀ and{ [symbol] ₁, . . . , [symbol] ₘ} respectively. When m=0 (body(r)=Ø), the above GAP-rule is called a fact. A GAP-rule is ground iff there are no occurrences of variables from either AVar or [symbol] in it. For ground rule r and ground literal [symbol] , bodyAnno( [symbol] , r)=μ such that [symbol] :μ appears in the body of r. A generalized annotated program Π is a finite set of GAP rules.

The formal semantics of GAPs are defined as follows. Note that we extend the notion of an interpretation to allow for a mapping of literals to annotations (as opposed to atoms). However, we add a requirement on the annotation between each atom and negation that ensures equivalence to the semantic structure of Kifer.

Definition A.4 (interpretation). An interpretation I is any mapping from the set of all grounds literals to [symbol] such that for literals a, ¬a, we have I(a)=¬(I(¬a)). The set [symbol] of all interpretations can be partially ordered via the ordering: I₁ [symbol] I₂ iff for all ground literals a, I₁( [symbol] ) [symbol] I₂( [symbol] ). [symbol] forms a complete lattice under the [symbol] ordering.

Now we present the satisfaction relationship:
Definition A.5 (Satisfaction). An interpretation I satisfies a ground literal [symbol] :μ, denoted I [symbol] [symbol] :μ, if ƒμ [symbol] I( [symbol] ). I satisfies the ground GAP-rule

$${ℓ}_{0} : {μ}_{0} ← {ℓ}_{1} : {μ}_{1} ⋀ … ⋀ {ℓ}_{m} : {μ}_{m}$$

$$( denoted I \vert = {ℓ}_{0} : {μ}_{0} ← {ℓ}_{1} : {μ}_{1} ⋀ … ⋀ {ℓ}_{m} : {μ}_{m} ) iif either$$

1. I satisfies [symbol] ₀:μ₀ or
2. There exists an 1≤i≤m such that I does not satisfy [symbol] ᵢ:μᵢ.
I satisfies a non-ground literal or rule iff I satisfies all ground instances of it.

We say that an interpretation I is a model of program Π if it satisfies all rules in Π. Likewise, program Π is consistent if there exists some I that is a model of Π. We say Π entails [symbol] :μ, denoted Π [symbol] [symbol] :μ, iff for every interpretation I s.t. I [symbol] Π, we have that I [symbol] [symbol] :μ. As shown by [6], we can associate a fixpoint operator with any GAP Π that maps interpretations to interpretations.

Definition A.6. Suppose Π is any GAP and I an interpretation. The mapping T_{Π} that maps interpretations to interpretations is defined as

$${T}_{Π} ( I ) ( {ℓ}_{0} ) = sup ( {annoSet}_{Π} ( {ℓ}_{0} ) ) ,$$

where annoSet_{Π,I}( [symbol] ₀)={I( [symbol] ₀)}∪{μ₀| [symbol] ₀:μ₀← [symbol] ₁:μ₁ ∧ . . . ∧ [symbol] ₘ:μₘ is a ground instance of a rule in Π, and for all 1≤i≤m, we have I [symbol] [symbol] ᵢ:μᵢ}

The key result of Kifer tells us that lfp(T_{Π}) precisely captures the ground atomic logical consequences of Π. We show this is also true (under the condition that Π is consistent) even if the annotations are based on a lower lattice. In Kifer, the authors also define the iteration of T_{Π} as follows:
T_{Π}↑0 is the interpretation that assigns ⊥ to all ground literals.
T_{Π}↑(i+1)=T_{Π}(T_{Π}↑i).

For each ground [symbol] ∈ [symbol] , the set Π( [symbol] ) is the subset of ground rules (to include facts) in Π where [symbol] is in the head. We will use the notation m [symbol] to denote the number of rules in Π( [symbol] ). For a given ground rule, we will use the symbol r [symbol] _{,i} to denote that it is the i-th rule with atom [symbol] in the head.

B. Formal Proofs for Results where the Lower Lattice Assumption is Made.

See P. Shakarian, G. I. Simari, Extensions to generalized annotated logic and an equivalent neural architecture, in: 2022 TransAI, 2022, pp. 63-70.

TABLE 5
Overview of the Honda Buyer-Supplier Network

| | |
|---|---|
| Companies (Nodes) | 10,893 |
| Buey-Supplier Relationships (Edges) | 47,247 |
| Global Industry Classification Standard (GICS) types | 67 |
| Edge Relationship types | 4 |

### C. Additional Details on Supply Chain Experiments

Table 5 summarizes the contents of the dataset. 7,396 companies were listed with a unique GICS, while 3,497 did not have one listed.

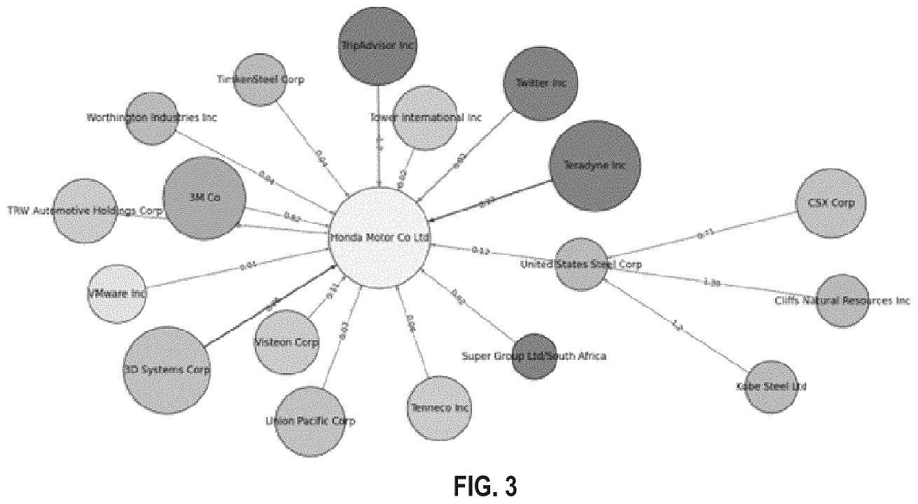

To understand the structure of the buyer-supplier network more in-depth, one industry along with its first and second Tier suppliers are mapped, as shown in FIG. 3, Each node shown in the figure contain an attribute name which describes the name of the industry and each edge connecting those industries contain an attribute cost which describes the profit relationship between those two particular industries connected by an edge.

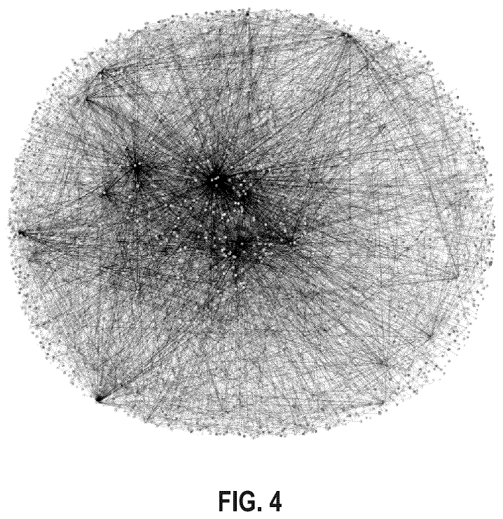

In FIG. 4 a portion of data is mapped out showing the complexity of the supply network. The figure can help identify a few key nodes which connect large sections of the network to other major sections—which makes them critical to operations.

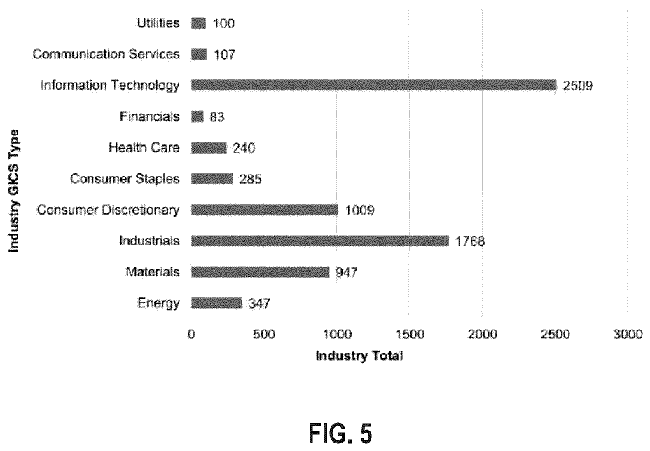

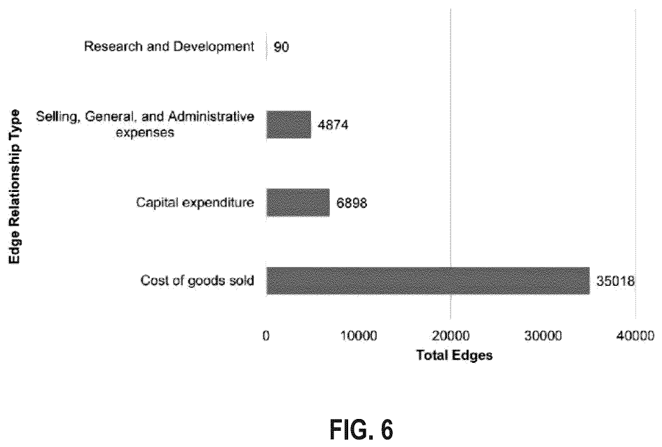

FIG. 5 shows the distribution of various industry types. FIG. 6 gives different edge relationships present in the dataset.

### D. Additional Details on Social Network Experiments

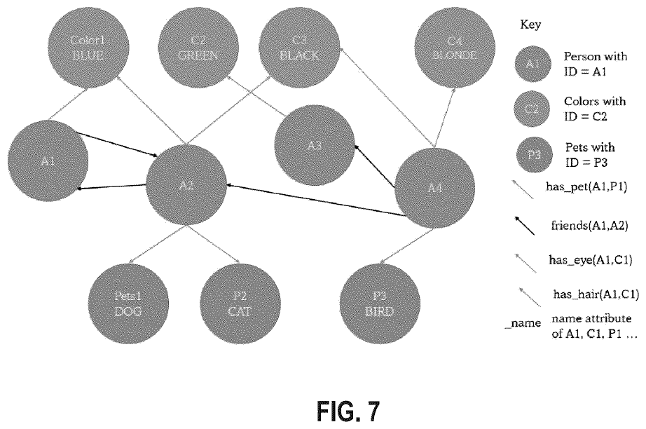

Table 6 gives an overview of the dataset, and the schema is shown in FIG. 7. The edge relationship types are enumerated in the figure.

Graph density represents the ratio between the edges present in a graph and the maximum number of edges that the graph can contain. In reality, graphs are often sparse (not dense). To test the scaling capacity of our approach with graph density, we re-run the experiment in Table 2 while modifying the density of the dataset. The results, in Table 7, show that the experiments on Honda data, which is about 40 times more dense than the Pokec network takes only about 3 times more memory, and 6 times more time to complete. This further showcases the scaling capability of our framework.

Finally, to test the scalability of our approach with respect to the number of attributes (and hence, number of ground atoms) in a graph, we run an experiment for a simple use-case—once with the original dataset, and then with the attributes added in. We define the use-case on the social media data as:

$$∀ X , Y infected ( X ) : [ 1 , 1 ] {←}_{Δ t = 1} infected ( Y ) : [ 1 , 1 ] ⋀ friend ( X , Y ) : [ 1 , 1 ]$$

which says, “A person contracts the virus if any of their friend(s) is infected by a virus”. The results are as shown in Table 8.

TABLE 6
Overview of the Pokec Social Media dataset

| | |
|---|---|
| Nodes | 1,632,820 |
| Edges | 31,633,113 |
| Node attribute types | 5 |
| Edge Relationship types | 4 |

### E. Expanded Rule Traces

A longer version of the rule trace in Table 4, with 10 atoms is presented in Table 9.

TABLE 7
Impact of graph density on memory and runtime

| | | Honda | | Pokec | |
|---|---|---|---|---|---|
| | | 4.10 × 10⁻⁴ | | 0.11 × 10⁻⁴ | |
| Nodes | Density→ | Runtime | Memory | Runtime | Memory |
| (N) | Timesteps | (in s) | (in MB) | (in s) | (in MB) |
| 10000 | 2 | 4.25 | 183.3 | 0.72 | 49.1 |
| | 5 | 6.11 | 235.9 | 0.99 | 69.5 |
| | 15 | 11.20 | 549.1 | 1.86 | 235.2 |

TABLE 8
Impact of adding 7 attributes on memory and runtime for 5 timesteps

| | Nodes | Edges | Grounded | Runtime | Memory |
|---|---|---|---|---|---|
| Attributes | (N) | (E) | atoms | (in mins) | (in GB) |
| Not | 1,632,803 | 30,622,563 | 3,265,606 | 20.07 | 43.53 |
| added | | | | | |
| Added | 1,632,820 | 31,633,113 | 36,531,539 | 31.73 | 92.52 |
| Change | (+17) | (+1,010,550) | (+33,265,933) | (+11.66) | (+48.99) |

### F. Implementation Pseudocode

Algorithm 1 enumerates the data structures in use. Algorithm 2 shows the initial state, while algorithm 3 details the inference process. During inference, interpretations are updated as shown in algorithm 4. Logical consistency is maintained using algorithms 5 and 6.

Algorithm 1 Data Structures Used

| | |
|---|---|
| 1: | Nested Dictionary I = [Node / Edge, [Predicate, [Lower, Upper, Static]]] to store |
| | current interpretations only. If Static is set to 1, bounds:Lower, Upper can no longer |
| | change for rest of program. |
| 2: | List L = [(Node / Edge, Predicate, Lower, Upper, Static, at_t)] to store facts and |
| | inferences, before it is used to update the dictionary. |
| 3: | List IPL = [(Predicate₁, Predicate₂)] containing pairs of predicates which cannot |
| | hold simultaneously, i.e., the bounds must be pairwise complementary. In the |
| | propositional case, if one of the predicates is true, the other must be false. We call |
| | this “inconsistent predicate list (IPL)”. |
| 4: | List E = [(Node /Edge, Predicate)] containing list of predicates that becomes |
| | inconsistent in the course of program execution. |

Algorithm 2 Program initialization

| 1: | I as follows: | |
|---|---|---|
| | ∀ nodes/edges, use type_checking to initialize valid predicates only. | |
| | All bounds are initialized to [0, 1]. Static set to 0. | |
| 2: | L < [ ] | [symbol] Empty list |

| | |
|---|---|
| | Facts (incl. initial interpretations) are then copied into L |
| 3: | t + 0 |
| 4: | E < [ ] |
| 5: | Input: Number of diffusion time-steps T, Set of rules R |

Algorithm 3 Program flow

| | |
|---|---|
| 1: | while t ≤ T do |
| 2: | for i in I, where (Static is false) do |
| 3: | reset bounds to [0, 1] |
| 4: | end for |
| 5: | update_req ← 0 |
| 6: | for l in L, where (l(at_t) == t) do |
| 7: | if check_consistency(l ∈ EL, l ∈ I) then |
| 8: | update_req += update_interp(l ∈ L, l ∈ I) |
| 9: | else |
| 10: | resolve_inconsistency(l ∈ I) |
| 11: | if (l,l′) ∈ IPL, ∀l′ then |
| 12: | resolve_inconsistency(l′ ∈ I) |
| 13: | end if |
| 14: | end if |
| 15: | end for |
| 16: | if update_req then |
| 17: | Apply fix-point operator(gamma) once. |
| 18: | for each resulting interpretation do |
| 19: | if Static is false in I then |
| 20: | Add to L |
| 21: | end if |
| 22: | end for |
| 23: | Go to line 5. |
| 24: | else |
| 25: | t ← t + 1. |
| 26: | end if |
| 27: | end while |

TABLE 9
Long rule trace for Label: relevance

| | | | Bound | | Rule | | | | |
|---|---|---|---|---|---|---|---|---|---|
| t | T | Node | Old | New | fired | Clause-1 | Clause-2 | Clause-3 | Clause-4 |
| 1 | 1 | 103247 | [0.0, 1.0] | [0.6, 1.0] | rule_1 | [(‘103247’, | | | |
| | | | | | | ‘1891’), . . . ] | | | |
| 1 | 1 | 165085 | [0.0, 1.0] | [0.6, 1.0] | rule_1 | [(‘165085’, | | | |
| | | | | | | ‘7667’), .. . ] | | | |
| 1 | 1 | 331934 | [0.0, 1.0] | [0.6, 1.0] | rule_1 | [(‘331934’, | | | |
| | | | | | | ‘331795’), . . . ] | | | |
| 1 | 1 | 358058 | [0.0, 1.0] | [0.6, 1.0] | rule_1 | [(‘358058’, | | | |
| | | | | | | ‘23201’), . . . ] | | | |
| 1 | 1 | 1246508 | [0.0, 1.0] | [0.6, 1.0] | rule_1 | [(‘1246508’, | | | |
| | | | | | | ‘326326’), . . . ] | | | |
| 1 | 1 | 1277197 | [0.0, 1.0] | [0.6, 1.0] | rule_1 | [(‘1277197’, | | | |
| | | | | | | ‘359728’), . . . ] | | | |
| 1 | 1 | 1333377 | [0.0, 1.0] | [0.6, 1.0] | rule_1 | [(‘1333377’, | | | |
| | | | | | | ‘435747’), . . . ] | | | |
| 1 | 1 | 1338343 | [0.0, 1.0] | [0.6, 1.0] | rule_1 | [(‘1338343’, | | | |
| | | | | | | ‘444138’), . . . ] | | | |
| 1 | 1 | 1389882 | [0.0, 1.0] | [0.6, 1.0] | rule_1 | [(‘1389882’, | | | |
| | | | | | | ‘530735’), . . . ] | | | |
| | 2 | 14496 | [0.0, 1.0] | [0.6, 1.0] | rule_1 | [(‘14496’, | | | |
| | | | | | | ‘544’), . . . ] | | | |
| | 2 | 103247 | [0.0, 1.0] | [0.6, 1.0] | rule_1 | [(‘103247’, | | | |
| | | | | | | ‘1891’), . . . ] | | | |
| 2 | 2 | 331934 | [0.0, 1.0] | [0.6, 1.0] | rule_1 | [(‘331934’, | | | |
| | | | | | | ‘331795’), . . . ] | | | |
| 2 | 2 | 1333377 | [0.0, 1.0] | [0.6, 1.0] | rule_1 | [(‘1333377’, | | | |
| | | | | | | ‘435747’), . . . ] | | | |
| 2 | 2 | 1389882 | [0.0, 1.0] | [0.6, 1.0] | rule_1 | [(‘1389882’, | | | |
| | | | | | | ‘530735’), . . . ] | | | |
| 3 | 3 | 1246508 | [0.0, 1.0] | [1.0, 1.0] | rule_2 | [‘326326’, . . . ] | [(1246508’, | [(‘803182’, | [(‘1246508’, |
| | | | | | | | ‘326326’), . . . ] | | |
| 3 | 3 | 1277197 | [0.0, 1.0] | [1.0, 1.0] | rule_2 | [‘359728’, . . . ] | [(1277197’, | [(‘802185’, | [(‘1277197’, |
| | | | | | | | ‘359728’), . . . ] | | |
| 3 | 3 | 1338343 | [0.0, 1.0] | [1.0, 1.0] | rule_2 | [‘444138’, . . . ] | [(‘1338343’, | [(‘1338341’, | [(‘1338343’, |
| | | | | | | | ‘444138’), . . . ] | | |
| 3 | 3 | 14496 | [0.0, 1.0] | [0.6, 1.0] | rule_1 | [(‘14496’, ‘544’), | | | |
| | | | | | | . . . ] | | | |
| 3 | 3 | 103247 | [0.0, 1.0] | [0.6, 1.0] | rule_1 | [(‘103247’ ‘1891’), | | | |
| | | | | | | . . . ] | | | |
| 3 | 3 | 331934 | [0.0, 1.0] | [0.6, 1.0] | rule_1 | [(‘331934’, ‘331795’), | | | |
| | | | | | | . . . ] | | | |
| 3 | 3 | 1333377 | [0.0, 1.0] | [0.6, 1.0] | rule_1 | [(‘1333377’, ‘435747’), | | | |
| | | | | | | . . . ] | | | |
| 3 | 3 | 1389882 | [0.0, 1.0] | [0.6, 1.0] | rule_1 | [(‘1389882’, ‘530735’), | | | |
| | | | | | | . . . ] | | | |

Algorithm 4 Updating interpretations

| | |
|---|---|
| 1: | procedure UPDATE_INTERP(i′, i) |
| 2: | updated ← 0 |
| 3: | if i(Lower)! = i′(Lower) (or) i(Upper)! = i′(Upper) then |
| 4: | i(Lower) ← fₗ(i(Lower), i′(Lower)) |
| | [symbol] by default fₗ is the max( ) function, but it can be user defined. |
| 5: | i(Upper) ← fᵤ(i(Upper), i′(Upper)) |
| | [symbol] by default fᵤ is the min( ) function, but it can be user defined. |
| 6: | updated ← 1 |
| 7: | end if |
| 8: | if updated (and) (i, ic) ∈ IPL, ∀ic then |
| 9: | ic(Lower) ← fₗ(ic(Lower), 1 − i(Upper)) |
| 10: | ic(Upper) ← fᵤ(ic(Upper), 1 − i(Lower)) |
| 11: | end if |
| 12: | return updated |
| 13: | end procedure |

Algorithm 5 Consistency checking

| | |
|---|---|
| 1: | procedure CHECK_CONSISTENCY(i′, i) |
| | [symbol] i′ is new interpretation with [L′, U′], and, i is current interpretation with [L, U] |
| 2: | if L′ > U (or) U′ < L then |
| 3: | return False |
| 4: | else |
| 5: | return True |
| 6: | end if |
| 7: | end procedure |

Algorithm 6 Inconsistency resolution

| | |
|---|---|
| 1: | procedure RESOLVE_INCONSISTENCY(i ∈ I) |
| 2: | i(Lower) ← 0 |
| 3: | i(Upper) ← 1 |
| 4: | i(Static) ← 1 |
| 5: | end procedure |

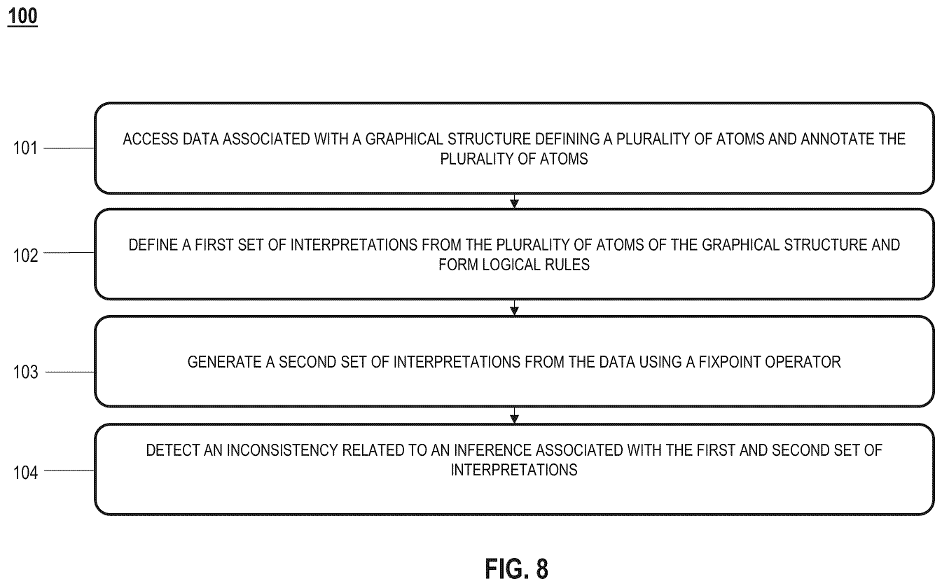

Exemplary Method/Process: Referring to FIG. 8, blocks 101-105 illustrate example functionality associated with the inventive concept described herein. In some examples, the steps of FIG. 8 define instructions and/or services that can be implemented as code and/or machine-executable instructions executable by the processor that may represent one or more of a procedure, a function, a subprogram, a program, a routine, a subroutine, a module, an object, a software package, a class, or any combination of instructions, data structures, or program statements, and the like. In other words, the instructions or any operations performed by the processor described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., memory), and the processor performs the tasks defined by the code.

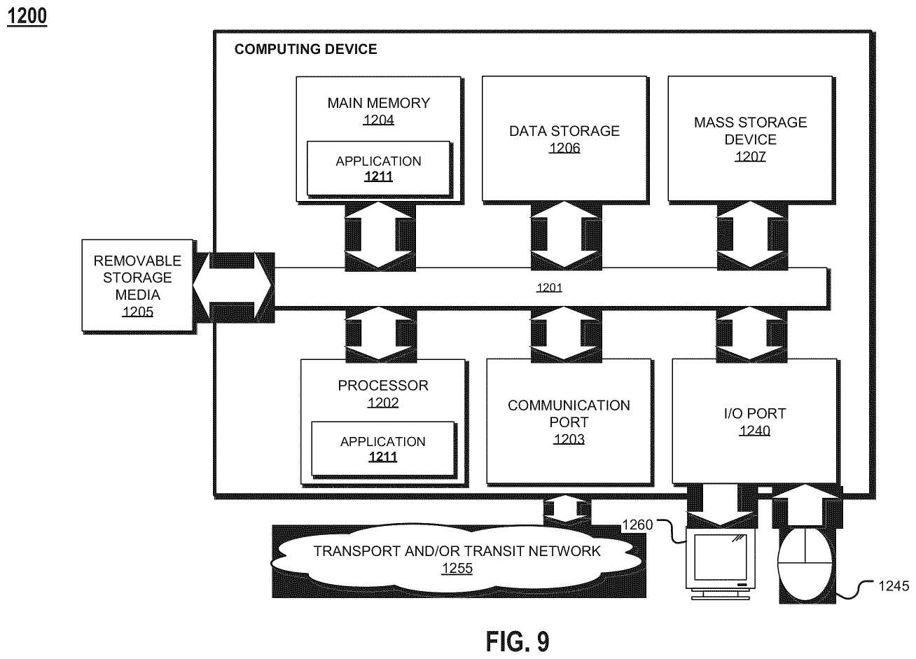

Exemplary Computing Device: Referring to FIG. 9, a computing device 1200 is illustrated which can be configured, via one or more of an application 1211 or computer-executable instructions, to execute functionality described herein. More particularly, in some embodiments, aspects of the predictive methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method of performing deductions via open world temporal logic, comprising:
accessing data associated with a graphical structure, the graphical structure defining a plurality of atoms;
annotating the plurality of atoms of the graphical structure;
defining, from the plurality of atoms of the data as annotated, a first set of interpretations as annotated function over predicates and time together;
forming logical rules based on the set of interpretations to enable changes to atoms formed with non-static predicates;
generating a second set of interpretations from the data using a fixpoint operator; and
detecting an inconsistency related to an inference associated with the first and second set of interpretations.

2. The method of claim 1, further comprising deducing logical inferences through applications of the fixpoint operator over predefined logical rules to detect a logical inconsistency and also located exactly where in a given inference process the logical inconsistency occurred.

3. The method of claim 1, further comprising detecting inconsistencies arising during execution of the fixpoint operator.

4. The method of claim 1, further comprising making logical inferences by exact application of the fixpoint operator to explain changes in an interpretation over time.

5. The method of claim 1, wherein implementation of the fixpoint operator accommodates, for any entailment query, a series of inference steps that lead to a given result to provide an explanation for deductive results.

6. The method of claim 1, further comprising type-checking while initializing the first and second set of interpretations to limit creation of ground atoms for the subset of predicate-constant pairs which are compatible with each other.

7. The method of claim 1, further comprising:
providing temporal annotations for the graphical structure wherein time is represented as finite discrete time-points.

8. The method of claim 1, further comprising:
annotating the plurality of atoms to support scalar-valued annotations by limiting manipulations to a lower bound of a given interval and keeping a corresponding upper bound set at 1.

9. The method of claim 1, further comprising incorporating a temporal component in the set of interpretations to enable temporal reasoning.

10. The method of claim 1, wherein the graphical structure defines a knowledge graph including nodes and edges having unary and binary predicates.

11. A method of performing deductions using annotated logic that incorporates multiple logic systems, comprising:
accessing data associated with a graphical structure, the graphical structure defining single elements and binary combinations;
implementing a framework to perform a deduction from the data, the framework configured to apply a plurality of logic systems in concert with each other, including:
constructing a plurality of statements from the data which can be treated as either false or true while incorporating fuzzy or in-between logic, and
performing the deduction from the data using the framework.

12. A computer-implemented framework for performing deductions using generalized annotated logic that incorporates a plurality of logic systems including neuro symbolic frameworks including the logical systems of fuzzy, open world, and temporal logic, and graph-based reasoning,
wherein the framework captures a current cohort of differentiable logics and temporal extensions to support inferences over finite periods of time and accommodates open world reasoning.

13. The computer-implemented framework of claim 12, wherein framework is configured to directly support reasoning over graphical structures and produces fully explainable traces of inference.
